(19) United States
(12) Patent Application Publication
(10) Pub. No.: US 2022/0114518 A1
(43) Pub. Date: Apr. 14, 2022

(54) COMPUTER SYSTEM AND COMPUTER IMPLEMENTED METHOD

(71) Applicant: DBAFC, L.L.C., MENLO PARK, CA (US)

(72) Inventor: Ismael Francis HISHON-REZAIZADEH, San Francisco, CA (US)

(21) Appl. No.: 17/498,685

(22) Filed: Oct. 11, 2021

Related U.S. Application Data
(60) Provisional application No. 63/090,366, filed on Oct. 12, 2020.

(51) Int. Cl. G06Q 10/06; G06N 20/00

(52) U.S. Cl. CPC G06Q 10/0635; G06N 20/00

(57) ABSTRACT

A system and method for determining a likelihood of future success of a business includes obtaining one or more sets of data associated with the business from one or more sources, storing the one or more sets of data in at least one database, retrieving the one or more sets of data from the at least one database and analyzing the one or more sets of data to determine a likelihood of future success of the business, and displaying to a user the likelihood of the success of the business.

### CROSS REFERNCE TO RELATED APPLICATIONS

The present application claims priority to Provisional Application No. 63/090,366 filed Oct. 12, 2020. The contents of this application are incorporated by reference into this application in its entirety.

### FIELD OF THE INVENTION

The present invention relates to systems and methods of collecting and analyzing data in the investment industry. In particular, the present invention relates to systems and methods of collecting and analyzing data to determine a likelihood of future success of a business for investment purposes.

### BACKGROUND OF THE INVENTION

Historically, the identification of companies for investment has been done through networking or by asking other investors for information. Additionally, people have historically manually combed through data sources like LinkedIn, Crunchbase and SimilarWeb to identify companies with interesting growth signals. Both of these processes are expensive and difficult to scale.

Thus, there is a need in the industry for more robust and efficient systems and methods of collecting and analyzing data about companies to identify early-stage companies that have a high probability of achieving long term success.

### SUMMARY OF THE INVENTION

The intention of the present invention is to create a more efficient process to identify companies through the use of data. Rather than just quantifying the magnitude of signals coming from companies, the present invention utilizes machine learning techniques on historical datasets to identify which features are significant to the eventual outcome of the company. Additionally, the present invention utilizes machine learning techniques to predict eventual outcomes of companies based on historical data from other similar companies. The combination of data elements utilized by the present invention is broader in scope than any existing technologies. The invention assesses a combination of professional histories of people from companies, as well as growth related metrics, e.g., web traffic, backlinks, clickthrough rate, web reviews and employee reviews.

The systems and methods of the present invention can be used as part of internal technologies that guide and provide insights to investors at the firm. These insights can also be provided to individuals at other firms as part of a reciprocal data exchange.

The present invention provides a system for determining a likelihood of future success of a business including an operation module and a display module. The operation module has a data collection module for obtaining one or more sets of data associated with the business from one or more sources, a database for storing the one or more sets of data associated with the business, and a processing module for retrieving the one or more sets of data from the database and analyzing the one or more sets of data to determine the likelihood of future success of the business. The display module displays the likelihood of the success of the business to a user.

In some embodiments, the one or more sets of data associated with the business includes at least one of a professional history of at least one employee of the business, a growth-related metric of the business, and at least one historical attribute associated with a plurality of businesses.

The operation module can further include a merging module for analyzing the one or more sets of data and extracting data that relates to the business using fuzzy logic.

In certain embodiments of the invention, the system further includes an extraction module for retrieving and processing the one or more sets of data from the database before the data is sent to the processing module, wherein the extraction module uses one or more predetermined features to extract a subset of data from the one or more sets of data to send to the processing module.

In some embodiments, the system of the invention also includes a historical data collection module for obtaining a set of data representing historical attributes associated with a plurality of businesses, a historical database for storing the set of data representing the historical attributes, and a training module for retrieving the set of data representing the historical attributes from the historical database, analyzing the set of data and training the processing module on the set of data. The processing module analyzes the one or more sets of data associated with the business using the trained data to evaluate the business.

The objectives of the present invention are further achieved by providing a method for determining a likelihood of future success of a business. One preferable embodiment of such method includes the steps of obtaining one or more sets of data associated with the business from one or more sources, storing the one or more sets of data in at least one database, retrieving the one or more sets of data from the at least one database and analyzing the one or more sets of data to determine a likelihood of future success of the business, and displaying to a user the likelihood of the success of the business.

In some embodiments, the one or more sets of data associated with the business include at least one of a professional history of at least one employee of the business, a growth-related metric of the business, and at least one historical attribute associated with a plurality of businesses.

The step of obtaining the one or more sets of data associated with the business may further include obtaining a set of data representing historical attributes associated with a plurality of businesses, wherein the method further includes the step of training processing module on the set of data representing historical attributes associated with the plurality of businesses, and the step of analyzing the one or more sets of data further includes analyzing attributes of the at least one business using the trained processing module to evaluate the business.

The training step may include analyzing the set of data representing historical attributes to derive relationships between input features and output labels, and the step of analyzing the one or more sets of data may include classifying novel inputs based on the derived relationships.

In certain embodiments of the invention, the business is an early-stage business, and wherein the historical data is data limited to the time the plurality of businesses were early-stage businesses. In some of these embodiments, the early-stage business is a business having between about 20 to about 100 persons associated with it and/or between about 1 million to about 12 million US dollars in revenue.

The method may further include the steps of obtaining new information relating to the one or more sets of data associated with the business from the one or more sources, updating the one or more sets of data stored in the at least one database with the new information, analyzing the new information and adjusting the likelihood of future success of the business, and displaying to the user the adjusted likelihood of the success of the business.

In some embodiments, the likelihood of success is displayed to the user as a score.

In certain embodiments of the invention, the one or more sets of data associated with the business include a professional history of a person, and the method further includes the step of assigning a value to the person based on their professional history. In some of these embodiments, the value represents a potential of contribution of the person to the business. In other embodiments, the value represents the likelihood of the person starting a business within a preselected time in the future.

The step of analyzing the one or more sets of data to determine a likelihood of future success of the business may include using an artificial intelligence module to analyze the one or more sets of data associated with the business.

The retrieving step of the method may include selecting a group of employees of the business and retrieving data representing professional history of the group of employees from the at least one database. In additional embodiments, the retrieving step may also include retrieving and processing the one or more sets of data from the database using one or more predetermined features to extract a subset of data from the one or more sets of data to send to the processing module.

In some embodiments, the step of obtaining one or more sets of data associated with the business may include analyzing the one or more sets of data and extracting data that relates to the business using fuzzy logic.

A further embodiment provides a system comprising: (a) a non-transitory computer-readable storage medium having program code embodied therewith, the program code executable by at least one hardware processor to perform the actions of any one of the preceding embodiments; and (b) at least one hardware processor configured to execute the program code.

In addition to the exemplary aspects and embodiments described above, further aspects and embodiments will become apparent by reference to the figures and by study of the following detailed description.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic diagram of the system of the present invention.

FIG. 2 is a combination of a software architectural diagram and a flow chart diagram of the method carried out by the system of the present invention.

FIG. 3a is a diagram of an embodiment of data collection and merging module used by the system of the present invention.

FIG. 3b is a diagram of an embodiment of historical data collection and merging module used by the system of the present invention.

### DETAILED DESCRIPTION OF THE INVENTION

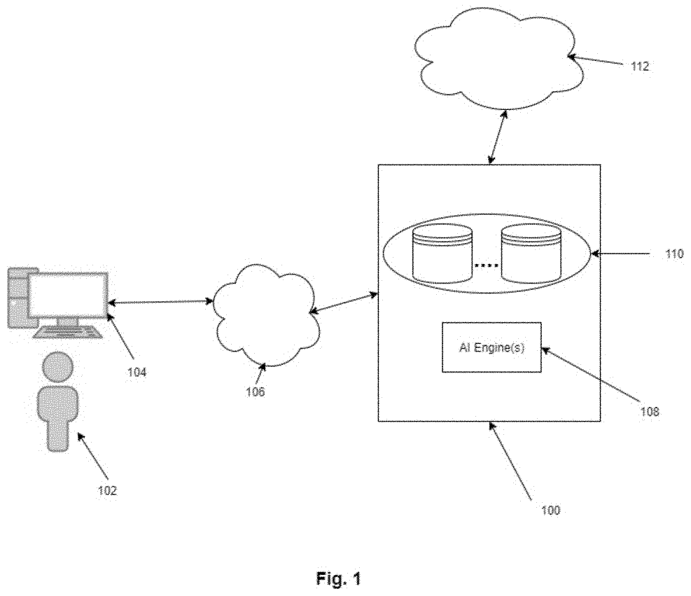

FIG. 1 is schematic diagram of a computer system 100 which uses artificial intelligence to evaluate data collected on business ventures and/or professional history of individuals to determine or predict the likelihood of their economic success in the future. Preferably, such businesses are early stage or start-up business ventures, herein referred to as “early-stage companies.” In FIG. 1, a user 102 interacts with a computer terminal 104, which is connected directly or through a network 106, whether an intranet or the internet or a combination of both, to computer system 100. Computer system 100 includes one or more AI engines 108 interacting with one or more databases 110 and with user 102 through computer terminal 104. Computer system 100 further interacts with the internet and sources of data 112. AI engines 108 analyze data associated with companies and/or professional histories of individuals to determine or predict the likelihood of their business success. Computer system 100 includes a processor.

Computer system 100 preferably gathers data from the internet and sources of data 112 on an ongoing and continual basis (in some embodiments, daily, hourly, or 24/7) to analyze companies and/or individuals. Therefore, AI engines 108 analyze the data and present the results of the analysis in real-time or near-real-time (NRT) to user 102. User 102 is shown the results of analysis by AI engines 108 as soon as changes in the data are obtained and analyzed, offering business advantage to user 102 over his/her competitors to invest in business or individuals. User 102 may also use the results of the AI engines' analysis as input for other analytical models or systems.

The likelihood of business success is based on the analysis of the likelihood of various economic outcomes and the scoring of the strength of an employee's background, i.e. professional history or resume, based on historical data. An economic outcome is defined as the history of acquisitions, debt issuance, equity investments received, grant financings received, bankruptcy, balance sheet information, revenue or profits of a company. Employee background strength is defined as a score derived from the strength of features extracted from an employee's previous or current employment information, education, certifications, awards, skill set, patents, publications and social media posts, likes, comments, groups, pages, followers, friends and connections. These scores may be tied both to the background of the individual, as well as the background in relation to the individual's current role. In some embodiments, analysis of what features constitute a strong background for an employee in a given role are derived from positive performance of other successful individuals in similar roles. Features associated with positive performance of an employee in a specific role include positive job performance, positive recommendations from peers and managers, successful economic outcomes for the company that employs them, and the production of high-quality work.

Note that the word “company” is not meant to designate a legal status but merely means a business, whether incorporated or not. The terms business, business ventures, and company will be used here interchangeably. User 102 can use the results of the analysis, on their own or as a supplement to other considerations, to decide whether to invest, through various methods of investing such as debt issuance, convertible debt, grant funding, equity investment, in one or more early-stage companies or to approach one or more early-stage companies to evaluate them further, or both.

Early-stage companies have various characteristics and are defined in various ways. For example, an early-stage company may be defined as a company that requires or seeks outside private investment, as opposed to public investment, to fuel its growth. An early-stage company may also be a company that is sought by private investors to invest in.

For example, the term early-stage company can refer to a company in the first stages of operations or a startup. Startups are founded by one or more entrepreneurs who want to develop a product or service for which they believe there is demand. These companies generally start with high costs and limited revenue, which is why they look for capital from a variety of sources such as venture capitalists. Typically, a startup is a company that is in the initial stages of business. Until the business gets off the ground, a startup is often financed by its founders and may attempt to attract outside investment. The many funding sources for startups include family and friends, venture capitalists, angel investors, crowd funding and loans.

Early-stage companies can also refer to business that have passed their early startup stage and can also have up to 250 or more employees. Early-stage companies can have zero or negative cash flow, or can have positive cashflow. Early-stage companies can even have raised up to 50-100 million US dollars or more in equity, debt and grand financing from a selected number of investors. In some embodiments, the early-stage company is a company having between about 20 to about 100 employees. In additional embodiments, the early-stage company is a company having about $1 to about $12 million in revenue and is raising an investment round between about $10 to about $50 million.

Early-stage companies can also be defined by having insufficient historic financial data or a track record to justify reliable forward projection of rapid growth that would justify investment. In other words, an early-stage company does not have historical and/or ongoing financial data to determine, by various types of financial analysis on that data, the value of its business.

An early-stage company can also be defined as a company whose value is not determined by its historical or ongoing financial situation but by the likelihood of its future growth. Therefore, current or historical financial data is not used by investors to determine the likelihood of the future success of company. Hence, in one embodiment, computer system 100 trains its AI engines 108 on historical data of other early-stage companies and their performance. AI engines 108 use that training knowledge to analyze data from current early stage companies to determine a scoring or a likelihood of their future performance.

In some embodiments, based on a predetermination that data on characteristics of employees and people associated with an early-stage company are a better gauge of future performance than current and/or historical data, computer system 100 analyzes data on those characteristics using AI engines 108, which assign a score or value to each employee and/or persons associated with company or assign a total score to a subset of those employees and/persons associated with the company. In addition, AI engines 108 can assign a value or score to a company based on the data on the characteristics of employees and people associated with that company. Computer system 100 then can present those scores to user 102. Since this analysis is ongoing based on the continuous updating of database 110, the information shown to user 102 reflects real-time (RT) or near-real-time (NRT) changes in currently available data from the internet and data sources 112.

In one embodiment of the computer system 100, the likelihood of success of an early-stage company is based on Artificial Intelligence (AI) derived analysis of data on the backgrounds of key employee.

For the purposes herein, the term “employee” is defined as not only individuals legally employed by an early-stage company, but more broadly as any person associated with the company who has an economic interest in the company and whose association typically includes working toward the success of the company. An employee can be company's founders, paid or unpaid outside advisors, board members, workforce, or any individual holding an economic interest in the form of equity or debt in the company. Employees do not include mere debtors whose debt is in the form of accounts receivable or mere customers of the company.

A key employee is one whose decisions can lead to changes in the future of the company or one who supervises the work done by one or more employees. Key employees are individuals, whether legally employed or not, who are closely associated with the company who can have an impact on its development and growth in the future. They often have an economic interest in the future success of the company either in the form of equity or debt in the company.

Computer system 100 through AI engine(s) 108 can identify the key employees of an early-stage company and determine the likelihood of success of the company based the data on those key employees. These individual include founders, executives, designers, product managers, engineers, and other employees in positions that puts them in charge of, or with ability to significantly contribute to, the future development of the company in various areas including product development, accounting, administrative, art and design, business development, community and social services, consulting, education, engineering, entrepreneurship, finance, healthcare services, human resources, information technology, legal, marketing, media and communication, military and protective services, operations, product management, program and project manager, purchasing, quality assurance, real estate, research, sales and support. Such individuals can also include outside advisors, outside board members, consultants and independent contractors. The composition of a company based on each of these areas can be used to identify or exclude companies based on the count, background strength or seniority of employees within each area. For example, the wrong composition of employees can lead to an unfavorable analysis of a company by an AI model or an investor.

In other embodiments computer system 100 uses AI engine(s) 108 to analyze all employees, some key and some non-key employees, or various other sets of employees to determine the likelihood of the success of the company.

In additional embodiments of the invention, the computer system 100 may gather other data associated with a particular business or related businesses form the internet and sources of data 112. The additional data includes various growth metrics, such as, e.g., website traffic, application downloads, web rankings, web reviews, employees' reviews, social media statistics, and others. This data is preferably gathered from the internet and sources of data 112 on an ongoing and continual basis (in some embodiments, daily, hourly, or 24/7). The Therefore, AI engines 108 analyze the data and present the results of the analysis in real-time or near-real-time to user 102. User 102 is shown the results of analysis by AI engines 108 as soon as changes in the data are obtained and analyzed, offering business advantage to user 102 over his/her competitors to invest in business or individuals.

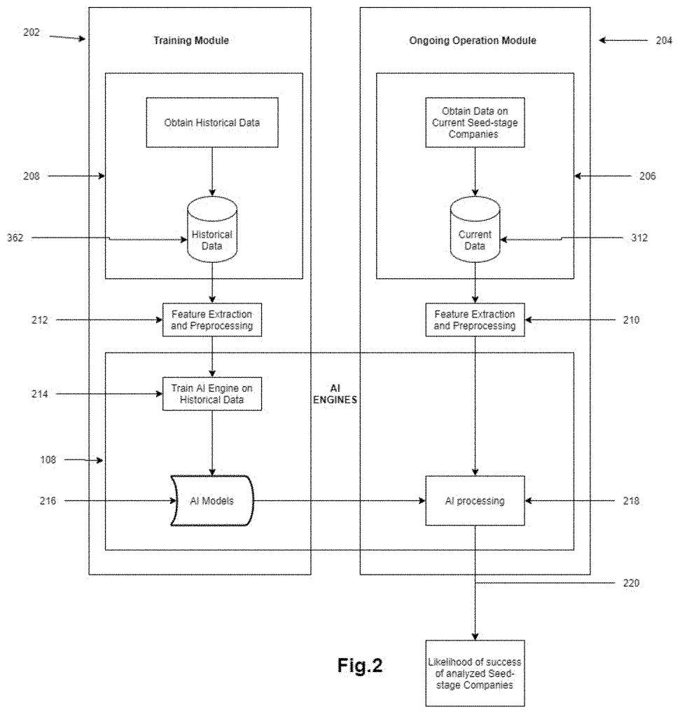

FIG. 2 shows a combination of a software architectural diagram and a flow chart diagram of the method carried out by the computer system 100. As shown in FIG. 2, the computer system 100 includes a training module 202 for gathering historical data on companies that were once early-stage and now have succeeded and/or failed and also data on employees and persons associated with those companies when they were early-stage companies. Training module 202 then trains AI engine(s) 108 on that historical data.

The computer system 100 also includes an ongoing operation module 204, which on an ongoing basis collects data on early-stage companies and on employees and people associated with those companies.

Ongoing operation module 204 then uses AI processes, trained in training module 202 on historical data, to analyze the data on the companies and on employees and people associated with those companies. AI processing of the data may then determine a score or a more thorough evaluation associated with each or a set of the employees and people associated with a company. AI process of the data may also predict or determine the likelihood of the future success of the early-stage companies it has analyzed. Ongoing operation module 204 collects data an ongoing basis, preferably on a continuous (24/7) basis, to capture any changes that might affect the analysis of the AI processing, so analysis is presented in real-time or near-real-time.

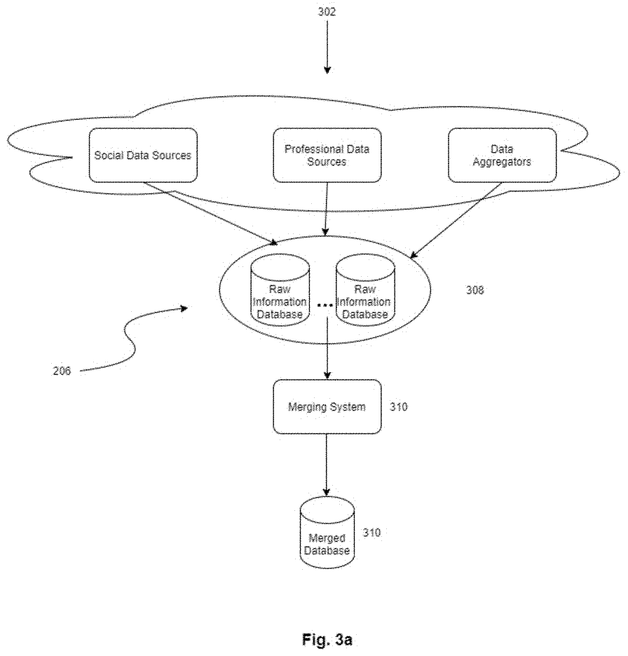

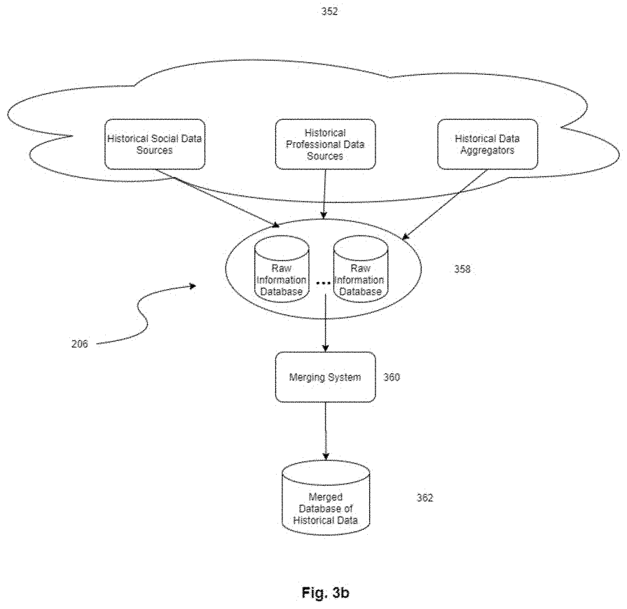

Ongoing operation module 204 includes a data collection and merging module 206. FIG. 3a shows a diagram of an embodiment of data collection and merging module 206 used by the computer system 100 for collecting data on early-stage companies and their employees. Data collection and merging module 206 gathers data 302 from various sources associated with early-stage companies and their employees from social media sources such as LinkedIn, Twitter, Facebook, news sources, press releases, academic publications, filed and granted patents, websites, graduate work, thesis papers and other sources. This data may be obtained either directly or through third-party date aggregators or providers or both.

Because the data obtained does not often clearly reference an early-stage company or an employee, the data collection and merging module 206 needs to infer how to merge data from disparate sources that relate to the same company and/or employee. To do so, a merging system 310 uses AI and fuzzy logic to fuzzy match records associated with the same company that were gathered from different sources.

In one embodiment of the merging system 310, a fuzzy matching approach is taken to merge employees with companies based on non-exact matches in the database. The merging system 310 handles merging between records for the same company that were gathered from different sites, the merging between records for the same person that were gathered from different sites, and the merging of records of employees associated with a specific company. The fuzzy merging may be done through identifying semantic difference, such as word vector distance, or the string distance between names, such as Levenshtein distance. Word vector distance merging creates word vectors embeddings where dimensions of a vector capture a words semantic meaning and merges based on similar semantic meaning. For example, while the words “king” and “queen” are different in string representation, they have a similar semantic meaning. String distance merging determines the number of single character edits, such as insertions, deletions or substitutions, between two words and merges accordingly.

The merging system 310 may also an AI based approach to fuzzy match records associated with the same company or employee that were gathered from different sources. This approach uses models with input features that are identifying information about the company such as company name, company industries, company business model, company location, company age, contact information, company logo, company descriptions and so forth. These features are used as input features to train supervised models that identify records for the same company that were gathered from different input sources. These models are trained on a dataset of known data belonging to the same companies derived from different input locations. In some embodiments of the system, these models may also use unsupervised approaches such as a deep belief networks (DBN), where there are connections between hidden layers but not between units within each layer. In other embodiments, additional machine learning models may be used to determine industries and business models for a given company. These models are trained to output the categories or business models of a company based on text descriptions related to the company and use these outputs as part of merging.

Merging system 310 also uses an AI based approach that fuzzy matches records associated with the same individuals that were gathered from different sources. This approach uses models with input features that are identifying information of a person, such as, name, age, geographical information, contact information, social media friends and connections, employment background, education background, current employment, awards, certifications, publications and so forth. These features are used as input features to train supervised models that identify records for the same person that were gathered from different input sources. These models are trained on a dataset of known data belonging to the same individuals derived from different input locations. In some embodiments of the system, these models may also use unsupervised approaches such as a deep belief networks (DBN).

Merging system 310 also uses an AI based approach to fuzzy match employees to the early-stage companies they are presently employed at or associated with or were previously employed at or associated with. In addition, merging system 310 matches employees to companies, institutions, or other organizations which are not early-stage companies. An employee's association with such companies, institutions, or organizations can provide valuable information to AI analysis of a seed-stage company and its success. These models use the identifying person features and the identifying company features defined above as input for supervised machine learning models that are trained to merge companies and their present or past employees. These models are trained on a dataset of known current and past employees of companies. In some embodiments of the system, these models may also use unsupervised approaches such as a deep belief networks (DBN).

The output of the merging system 310 is stored in a database 312. Database 312 therefore will contain: data gathered and associated with various companies; data gathered and associated with various individuals; and data on the relationships between those individuals and companies, if any. The data on the relationships can be about present or past associations. Such associations may have different characteristics as described above in relation to the definition of employee herein. In short, for each individual, database 312 stores an association or employment history which sets out the various relationships between that individual and various companies, institutions, and organizations that individual has been associated with. Database 312 also contains information about non-early-stage companies where such information can be useful to AI engines 108 in determining or predicting the likelihood of success of early-stage companies.

Referring back to FIG. 2, training module 202 includes a historical data collection and merging module 208. This module functions in much the same way as data collection and merging module 206, except that it gathers data on companies which were previously early-stage companies but now range from failed to highly successful companies. The data gathered will be data that was available on those companies and their employees when they were early-stage companies so that the AI engines 108 can be trained on the same kind of data that is currently available for early-stage companies, except that these historical companies can guide the training to determine which particular characteristics of companies and/or their employees, at their early-stage, exist among successful companies and/or unsuccessful companies and degree those characteristics correlate with the degree of financial success of the companies. In one advantageous embodiment, the training module 202 gathers data on companies that have been financed within their early stage within the past ten years.

FIG. 3b shows a diagram of an embodiment of the historical data collection and merging module 208 used by the computer system 100 for collecting data on early-stage companies and their employees. Historical data collection and merging module 208 gathers data 352 from various sources associated with various non-early-stage companies at their early-stage and their employees from social media sources such as LinkedIn, Twitter, Facebook, news sources, press releases, academic publications, filed and granted patents, websites, graduate work, thesis papers and other sources. This data may be obtained either directly or through third-party date aggregators or providers or both.

Because the data obtained does not often clearly reference a company or an employee, historical data collection and merging module 208 needs to infer how to merge data from disparate sources that relate to the same company and/or employee. To do so, a merging system 360 uses AI and fuzzy logic to fuzzy match records associated with the same company that were gathered from different sources.

In one embodiment of the merging system 360, a fuzzy matching approach is taken to merge employees with companies based on non-exact matches in the database. The merging system 360 handles merging between records for the same company that were gathered from different sites, the merging between records for the same person that were gathered from different sites and the merging of records of employees associated with a specific company. The fuzzy merging may be done through identifying semantic difference, such as word vector distance, or the string distance between names, such as Levenshtein distance. Word vector distance merging creates word vectors embeddings where dimensions of a vector capture a words semantic meaning and merges based on similar semantic meaning. For example, while the words “king” and “queen” are different in string representation, they have a similar semantic meaning. String distance merging determines the number of single character edits, such as insertions, deletions or substitutions, between two words and merges accordingly.

The merging system 360 may also an AI based approach to fuzzy match records associated with the same company or employee that were gathered from different sources. This approach uses models with input features that are identifying information about the company such as company name, company industries, company business model, company location, company age, contact information, company logo, company descriptions and so forth. These features are used as input features to train supervised models that identify records for the same company that were gathered from different input sources. These models are trained on a dataset of known data belonging to the same companies derived from different input locations. In some embodiments of the system, these models may also use unsupervised approaches such as a deep belief networks (DBN) where there are connections between hidden layers but not between units within each layer. In other embodiments, additional machine learning models may be used to determine industries and business models for a given company. These models are trained to output the categories or business models of a company based on text descriptions related to the company.

Merging system 360 also uses an AI based approach fuzzy matches records associated with the same individuals that were gathered from different sources. This approach uses models with input features that are identifying information of a person, such as, name, age, geographical information, contact information, social media friends and connections, employment background, education background, current employment, awards, certifications, publications and so forth. These features are used as input features to train supervised models that identify records for the same person that were gathered from different input sources. These models are trained on a dataset of known data belonging to the same individuals derived from different input locations. In some embodiments of the system, these models may also use unsupervised approaches such as a deep belief networks (DBN).

Merging system 360 also uses an AI based approach to fuzzy match employees to early-stage companies they were presently employed or associated with or were previously employed at or associated with at the time the historical data was gathered. In addition, merging system 360 matches employees to companies, institutions, or other organizations which are not early-stage companies. An employee's association with such companies, institutions, or organizations can provide valuable information to AI analysis of an early-stage company and its success. These models use the identifying person features and the identifying company features defined above as input for supervised machine learning models that are trained to merge companies and their present or past employees. These models are trained on a dataset of known current and past employees of companies. In some embodiments of the system, these models may also use unsupervised approaches such as a deep belief networks (DBN).

The output of the merging system 360 is stored in database 362. Database 362 therefore will contain historical data comprising: data gathered and associated with various companies; data gathered and associated with various individuals; and data on the relationships between those individuals and companies, if any. Data on various companies includes historical economic outcomes associated with those companies. The data on the relationships can be about present or past associations. Such associations may have different characteristics as described above in relation to the definition of employee herein. In short, for each individual, database 362 stores an association or employment history which sets out the various relationships between that individual and various companies, institutions, and organizations that individual has been associated with. Database 362 also contains information about non-early-stage companies where such information can be useful in training AI engines 108.

Referring back to FIG. 2, the data in databases 312 and 362 are preprocessed and features extracted from them in steps 210 and 212, respectively, so that the data is then in a form that can be consumed by AI engines. It should be noted that the data in database 312 is continually updated so as to preferably provide near real-time (NRT) results of AI processing to users of computer system 100, unlike the data in 362, which is used for training AI Engines 108 and creating AI models 216 and need not be updated unless for retraining of AI engines 108.

The preprocessing and features extraction steps 210 and 212 are nearly identical, since as with the data, there preferably should be an equivalency of features on which the AI engines 108 are trained and features on which AI engines 108 operate to analyze, assess, predict, and determine the likelihood of economic success of early-stage companies and the strength of their employees.

Database 312 includes data on the backgrounds of individuals and various early-stage companies. Database 362 includes data on the backgrounds of individuals and various companies at the point in time they were early-stage companies. In the preprocessing and feature extraction steps 210 and 212, features are extracted from the data and the data is preprocessed to be used as input AI engines 108. The data may be preprocessed through established methods such as cleaning, instance selection, transformation, normalization, data reduction and so on.

In some embodiments, steps 210 and 212 use established data mining techniques to extract features that have previously been identified as having high correlation to positive economic outcomes of companies. Examples of this may include features whose significance is derived by principal component analysis (PCA) or singular value decomposition (SVD). In other embodiments, steps 210 and 212 extract predefined features specified by the creator which may have no predefined statistical relationship to historical economic outcomes or employee background strengths. Extracted data from the feature extraction engine is transferred to the AI engines 108 over a network. In some embodiments of this system, steps 210 and 212 may be bypassed and the AI engines 108 consume the data directly from databases 312 and 361.

Features extracted from employees' backgrounds in steps 210 and 212 include full education history by each individual, comprising the schools and universities attended, length of their course of study, the degree obtained by that individual, academic rankings associated with the school or university, the years in which the university was attended, age of the individual when the university was attended, publications and citations derived from research done at each university, awards received from each university and so on. Features extracted from employees' backgrounds also include full career and volunteer history, comprising the companies that an individual has worked at or been associated with, the length of employment, the seniority at each company, the role at each company, the departments worked in by each individual, performance reviews and recommendations received by that individual, projects completed by the individual, patents obtained by the individual, promotions received by the individual, publications and citations received by the individual, length of the career of the individual, awards received by the individual, career trajectory of the individual, and so on. Other features looked at include, network size and social media presence of the individual, team composition, network composition, growth in social media following and presence of the individual, geographical location of the individual, licenses and certifications received by the individual, languages spoken by the individual, articles written by the individual, test scores of the individual, organizations belonged to by the individual, honors received by the individual, skills the individual has, recommendations and endorsements received in the context of each skill had by an individual, activity level of the individual on social and professional sites, courses taken by the individual and so on.

In some embodiments, features are extracted from backgrounds in an unsupervised fashion. In some embodiments, autoencoders are trained on a high dimensionality of input features with the goal of minimizing signal noise within the data. The autoencoder attempt to reconstruct of economic outcome labels and employee background strength labels from fewer inputs than they originally received. This removes the features with low significance to the intended output. In other embodiments, a principal component analysis (PCA) is used to project each data point in an n-dimensional space onto a reduced number of principal components, with the goal of obtaining a lower-dimensionality of input data.

In the case of training module, after step 212, AI engines 108 are trained on the output of step 212 in step 214 to produce AI models 216. In embodiments using supervised AI models, AI models 216 are trained by a historical analysis of a dataset consisting of labeled economic outcomes or employee background strengths, in conjunction with specific input features. This dataset provides the strength of an employee background or historical company outcomes, and the input features associated with employee(s). These models are able to derive relationships between the input features and output labels based on analysis of historical data. Once trained, these models can classify novel inputs according to relationships identified from the training data. Examples of models using this supervised approach include neural networks, support vector machines and Naïve Bayes classifiers.

In an embodiment using a supervised or unsupervised approach, where AI models 216 include neural networks, features are used to train a neural network based on historical economic outcomes or employee background strength. The supervised approach uses the input features, as derived previously, and uses economic outcomes or employee background strength as labels for the model to output. Input data is prepared using conventional methods and split into a training set to train the model, a validation set to tune hyperparameters and testing set to validate the efficacy of the model. In some embodiments text data will be transformed into word vector embeddings where the meaning of words is reflected in a point in n-dimensional space and similar semantic words are represented in similar vectors. In some embodiments unsupervised machine learning techniques may be used for dimensionality reduction of the input features, such as a principal component analysis (PCA) or a generalized discriminant analysis (GDA). In one embodiment, additional machine learning based analysis is done on the current and past job titles of all employees, to determine their seniority, department, responsibilities, role and so on. This analysis is done through a supervised text classification model that analyzes the job title as text or as a word vector input, with the output labels as seniority, department, responsibilities, role and so on.

Some embodiments of the AI models 216 may use unsupervised techniques such as a deep belief network (DBN) where there are connections between hidden layers but not between units within each layer. When trained without supervision DBNs, can improve feature detection through learning to probabilistically reconstruct inputs.

In embodiments using neural networks, the networks are subsequently trained using batch, stochastic or mini-batch gradient descent and back propagation. Model performance is assessed using accuracy, precision and F1 score. The assessment is based on predicted economic outcomes or employee background strengths derived from input features of a given company, compared to actual historical economic outcomes of that company or strength of an employee's background.

In other embodiments, AI models 216 may be derived from a rules-based approach that determines a score or likelihood of a company's economic outcomes or the strength of an employee's background from a set of predefined rules. Examples of models using this approach include symbolic systems, rules engines and decision trees. In these systems, rules are codified to score and predict the likely economic outcome based on specific criteria. In some embodiments, these criteria may be derived from human intuition, rather than a statistical assessment of relevant features. Examples of features examined may include individuals with PhDs, individuals with MBAs, individuals who have previously founded companies that were acquired and individuals with academic publications. In other embodiments, these rules are derived from a combination of supervised and unsupervised methods, in conjunction with employees' background to extract relevant features with a significant relationship to historical economic outcomes or background strength. Examples of these feature extraction systems include principal component analysis (PCA) or a generalized discriminant analysis (GDA), where relevant features are derived from analysis of principal components or covariance of features in relation to historical data.

In other embodiments, AI models 216 may use an unsupervised approach to determine the likelihood of different economic outcomes based on training data consisting of the backgrounds of individuals associated different companies. These models may not use output labels and instead identify trends solely based on input features. Examples of models used in this approach include deep belief nets, Density-based spatial clustering of applications with noise (DBSCAN), hierarchical clustering, and so on.

Some embodiments of this system use another set of AI models 112 to analyze the results of the prior analysis to select companies for specific financing decisions. In some embodiments, these AI models 112 are trained in a supervised fashion using data on financers' specific goals (e.g. user 102) and are optimized to identify companies that will likely reach desired outcomes. Examples of models used in this approach include neural networks, support vector machines and Naïve Bayes classifiers. Other embodiments of the system 112 use a rules-based approach to determine suitability of investment based on rules codified to identify specific outcomes derived from the prior historical analysis. Examples of models used in this approach include decision trees, rules engines and symbolic systems. Other embodiments use unsupervised AI techniques 112 for both identification of companies with a likelihood of specific economic outcomes or for further feature extraction. Examples of models used in this approach include deep belief nets, Density-based spatial clustering of applications with noise (DBSCAN), hierarchical clustering, and so on.

Once AI models 216 have been trained, AI engines 108 in step 218 will use AI models 216 to process and analyze data output of step 210 using artificial intelligence. The model and the accompanying software needed to run the model are packaged into Docker containers to create the AI processing module 218. Docker is a set of platform as a service (PaaS) products that use OS-level virtualization to deliver software in packages called containers. Containers are isolated from one another and bundle their own software, libraries and configuration files; they can communicate with each other through well-defined channels. The accompanying software is defined as any software or code required for the AI models to analyze data sent to it over the network. This includes but is not limited to programmatic libraries needed to create a connection with the feature extraction and preprocessing module 210. The Docker containers consisting of the trained AI model 216 are deployed onto a server to create the AI processing module 218. Note the word “server” does not merely designate a physical server but instead an environment where code can run, such as cloud servers, serverless runtime environments, virtual machines and so forth. In some embodiments, a container orchestration tool is used, such as Docker Swarm or Kubernetes, to manage the deployment and scaling of the containers. Once the trained AI models are deployed, the AI processing module 218, can analyze data sent to it over a network.

In some embodiments, the AI processing step 218 receives data sent to it for analysis through an Application Programing Interface (API). An application programming interface (API) is a computing interface which defines interactions between multiple software intermediaries. It defines the kinds of calls or requests that can be made, how to make them, the data formats that should be used, the conventions to follow, etc. Through an API, data to be analyzed can be received and processed by the AI processing module 218 and resulting analysis 220 can be outputted. This outputted analysis may be stored in a database, file storage system or used as input for another application.

After the AI processing step 218, the results may be stored for future use and/or presented to the user.

In some embodiments, rather than predicting economic outcome from the backgrounds of employees across an entire company, predictions on economic outcomes are derived from a second analysis of the primary scoring of employees' background strength. Once employees' backgrounds are scored, the aggregation of scores are used to determine a score for the company. The aggregation can be done through simple mathematical methods such as weighted averaging or through more complicated methods such as ensemble averaging of the outputs of multiple predictive models. In one embodiment, the output of the score assigned to each employee, in conjunction with the area of the company that each employee works in, the employee's seniority and the count of employees per area are used as input for a supervised machine learning model. The model, trained on historical economic outcomes and the input features associated with them, is designed to score the strength of each company based on its employees' backgrounds and provide the likelihood of specific economic outcomes. In some embodiments of the system, the model may also use unsupervised approaches such as a deep belief networks (DBN).

In some embodiments of the system, rather than predicting the likelihood of certain economic outcomes or scoring employees based on their background strength, AI Engines 108 are designed to predict the likelihood of an individual founding an early-stage company based on their backgrounds in the future, having characteristics suitable to be associated with a particular early-stage company with which he is not associated it with, and/or having the characteristics indicating that a startup company he/she starts will have a good likelihood to succeed. AI models 216 are trained on historical data comprising of backgrounds of individuals who have gone on to found companies or been involved with successful early-stage companies. These models can be trained, as discussed previously with respect to training AI models 216 on historical method, using various known artificial intelligence training methods such as supervised, unsupervised, rules-based with similar architectures, and so on. Using the that data AI models 216, AI processing module 218 may then analyze data that is gathered on individuals, whether currently associated with early-stage companies or not, on an ongoing basis by ongoing operation module 204.

In yet other embodiments, additional analysis is done comparatively between companies operating in similar industries, companies with similar business models or based on other similarities decided analytically or by a human. The comparative analysis can be done statistically to identify the highest likelihood of specific outcomes or companies with the highest scores in the same or across different categories. The comparative analysis can also be done to sort or filter results that are displayed to a human or used in further analysis. In one embodiment, the comparison analysis is used to create graphs showing the strongest companies in each industry and with each business model for humans to analyze as part of making financing decisions. In another embodiment, the comparative analysis is done for employees of a company. The analysis compares the scores and likelihood of specific outcomes assigned to each employee of a company to employees in similar roles in other companies. This analysis is also conducted by seniority level, comprising of Founders, Executives, Managers, Employees, Investors and so on, and areas of the company.

In further embodiments, the system can infer the magnitude of exit events, such as acquisitions and IPOs, for companies where the data is not publicly available, using a probability distribution created through surveying investors. The investors estimate the probability that the exit multiple is within a specific range, and the average of the estimates by all investors is used to create a data point to train the predictive models.

Referring back to FIG. 1, in some embodiments, user 102 can adjust weights of the rules-based AI models and include or exclude features for analysis by the supervised or unsupervised AI models through a user interface on the web terminal. A user interface on the web terminal is defined as any desktop application interface, web application interface, mobile application interface and so on, that can be used to display information to a human and be interacted with. This allows fine tuning of the analytics models to specific investor preferences. In other embodiments, a user 102 can directly adjust weights of the rules-based AI models and include or exclude features for analysis by the supervised or unsupervised AI models through changing or requesting to change the underlying code.

In yet other embodiments, the system uses another set of AI models 112 to analyze the results of the prior analysis to select companies for a specific financing decisions. In some embodiments, these AI models 112 are trained in a supervised fashion using data on financers' specific goals and are optimized to identify companies that will likely reach desired outcomes. Examples of models used in this approach include neural networks, support vector machines and Naïve Bayes classifiers. Other embodiments of the system 112 use a rules-based approach to determine suitability of investment based on rules codified to identify specific outcomes derived from the prior historical analysis. Examples of models used in this approach include decision trees, rules engines and symbolic systems. Other embodiments use unsupervised AI techniques 112 for both identification of companies with a likelihood of specific economic outcomes or for further feature extraction. Examples of models used in this approach include deep belief nets, Density-based spatial clustering of applications with noise (DBSCAN), hierarchical clustering, and so on.

In some embodiments of the system, rather than predicting the likelihood of certain economic outcomes or scoring employees based on their background strength, AI Engines 108 are designed to predict the likelihood of an individual founding an early-stage company based on their backgrounds in the future, having characteristics suitable to be associated with a particular early-stage company with which he is not associated it with, and/or having the characteristics indicating that a startup company he/she starts will have a good likelihood to succeed . AI models 216 are trained on historical data comprising of backgrounds of individuals who have gone on to found companies or been involved with successful early-stage companies. These models can be trained, as discussed previously with respect to training AI models 216 on historical method, using various known artificial intelligence training methods such as supervised, unsupervised, rules-based with similar architectures, and so on. Using the data AI models 216, AI processing module 218 may then analyze data that is gather on individuals, whether currently associated with early-stage companies or not, on an ongoing basis by ongoing operation module 204.

Other embodiments of this system may use the outcome of the analysis of employee backgrounds to advise or improve human made financing decisions in relation to specific economic outcomes. An embodiment of this system presents the results of analysis in the form of a human readable output either in the form of raw data or in the form of a software application. Raw data is defined as any data or extract of data used by a human as part of making a decision in relation to target economic outcomes. A software application is defined as any desktop application, web application, mobile application and so on, that can be used to display analysis information to a human. An individual uses the human readable output with the goal of advising part or all of their traditional decision-making process associated with a financing decision. Some embodiments of the system use the analysis provided by the AI models to filter out companies that have a likely outcome that is different from an individual's goal outcomes. The companies that remain after filtering based on predicted economic outcomes are presented either in the form of raw data or in the form of a software application to an individual with the goal of advising part or all of their decision-making process in relation to an economic outcome.

Reference herein to details of the illustrated embodiments is not intended to limit the scope of the claims, which themselves recite those features regarded as essential to the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for determining a likelihood of future success of a business comprising:
an operation module; and
a display module;
wherein the operation module comprises:
a data collection module for obtaining one or more sets of data associated with the business from one or more sources;
a database for storing the one or more sets of data associated with the business; and
a processing module for retrieving the one or more sets of data from the database and analyzing the one or more sets of data to determine the likelihood of future success of the business;
wherein the display module displays the likelihood of the success of the business to a user.

2. The system of claim 1, wherein the one or more sets of data associated with the business comprise at least one of a professional history of at least one employee of the business, a growth-related metric of the business, and at least one historical attribute associated with a plurality of businesses.

3. The system of claim 1, wherein the operation module further comprises a merging module for analyzing the one or more sets of data and extracting data that relates to the business using fuzzy logic.

4. The system of claim 1, further comprising an extraction module for retrieving and processing the one or more sets of data from the database before the data is sent to the processing module, wherein the extraction module uses one or more predetermined features to extract a subset of data from the one or more sets of data to send to the processing module.

5. The system of claim 1, further comprising:
a historical data collection module for obtaining a set of data representing historical attributes associated with a plurality of businesses,
a historical database for storing the set of data representing the historical attributes; and
a training module for retrieving the set of data representing the historical attributes from the historical database, analyzing the set of data and training the processing module on the set of data,
wherein the processing module analyzes the one or more sets of data associated with the business using the trained data to evaluate the business.

6. A method for determining a likelihood of future success of a business comprising the steps of:
obtaining one or more sets of data associated with the business from one or more sources;
storing the one or more sets of data in at least one database;
retrieving the one or more sets of data from the at least one database and analyzing the one or more sets of data to determine a likelihood of future success of the business; and
displaying to a user the likelihood of the success of the business.

7. The method of claim 6, wherein the one or more sets of data associated with the business comprise at least one of a professional history of at least one employee of the business, a growth-related metric of the business, and at least one historical attribute associated with a plurality of businesses.

8. The method of claim 6, further comprising the steps of:
obtaining a set of data representing historical attributes associated with a plurality of businesses; and
training a processing module on the set of data representing historical attributes associated with the plurality of businesses;
wherein the step of analyzing the one or more sets of data includes analyzing attributes of the at least one business using the trained processing module to evaluate the business.

9. The method of claim 8, wherein the training step comprises analyzing the set of data representing historical attributes to derive relationships between input features and output labels, and wherein the step of analyzing the one or more sets of data comprises classifying novel inputs based on the derived relationships.

10. The method of claim 8, wherein the business is an early-stage business, and wherein the historical data is data limited to the time the plurality of businesses were early-stage businesses.

11. The method of claim 10, wherein the early-stage business is a business having between about 20 to about 100 persons associated with it and/or between about 1 million to about 12 million US dollars in revenue.

12. The method of claim 6, further comprising the steps of:
obtaining new information relating to the one or more sets of data associated with the business from the one or more sources;
updating the one or more sets of data stored in the at least one database with the new information;
analyzing the new information and adjusting the likelihood of future success of the business; and
displaying to the user the adjusted likelihood of the success of the business.

13. The method of claim 6, wherein the likelihood of success is displayed to the user as a score.

14. The method of claim 6, wherein the one or more sets of data associated with the business comprises a professional history of a person, and wherein the method further comprises the step of assigning a value to the person based on their professional history.

15. The method of claim 14, wherein the value represents a potential of contribution of the person to the business.

16. The method of claim 14, wherein the value represents the likelihood of the person starting a business within a preselected time in the future.

17. The method of claim 6, wherein the step of analyzing the one or more sets of data to determine a likelihood of future success of the business comprises using an artificial intelligence module to analyze the one or more sets of data associated with the business.

18. The method of claim 6, wherein the retrieving step further comprises selecting a group of employees of the business and retrieving data representing professional history of the group of employees from the at least one database.

19. The method of claim 6, wherein the retrieving step comprises retrieving and processing the one or more sets of data from the database using one or more predetermined features to extract a subset of data from the one or more sets of data to send to the processing module.

20. A system for determining a likelihood of future success of a business comprising:
(a) at least one hardware processor; and
(b) a non-transitory computer-readable storage medium having program code embodied therewith, the program code executable by said at least one hardware processor to:
obtain one or more sets of data associated with the business from one or more sources;
store the one or more sets of data in at least one database;
retrieve the one or more sets of data from the at least one database and analyzing the one or more sets of data to determine a likelihood of future success of the business; and
display to a user the likelihood of the success of the business.
